(19) United States
(12) Patent Application Publication
(10) Pub. No.: US 2023/0408836 A1
(43) Pub. Date: Dec. 21, 2023

(54) Optical Element and Optical Module

(71) Applicant: Daicel Corporation, Osaka (JP)

(72) Inventors: Takeshi Fujikawa, Tokyo (JP); Makoto Yasuhara, Tokyo (JP); Sadayuki Fukui, Tokyo (JP)

(73) Assignee: Daicel Corporation, Osaka (JP)

(21) Appl. No.: 18/210,183

(22) Filed: Jun. 15, 2023

(30) Foreign Application Priority Data
Jun. 15, 2022 (JP) 2022-096873

(51) Int. Cl. G02B 27/30; G02B 3/04; G02B 1/04; G02B 1/11

(52) U.S. Cl. CPC G02B 27/30; G02B 3/04; G02B 1/041; G02B 1/11; G02B 19/0052

(57) ABSTRACT

A technology that can improve efficiency of or simplify a structure of an optical system having a collimating function configured to collimate incident light and a function configured to diffuse or condense parallel light is provided. An optical element includes a function configured to make parallel light into outgoing light by diffusing the parallel light or condensing the parallel light to form a specific pattern, on one surface, and a collimating function configured to make incident light into parallel light by an aspherical lens shape, on the other surface. This makes it possible to achieve a function configured to make outgoing light by diffusing incident light or condensing the incident light to form a specific pattern with a simpler structure. Incident light can be made into parallel light more efficiently even in a case of using a surface light source.

### CROSS-REFERENCE TO RELATED APPLICATION

This application is based upon and claims the benefit of priority of the prior Japanese Patent Application No. 2022-096873, filed on Jun. 15, 2022, the entire contents of which are incorporated herein by reference.

### TECHNICAL FIELD

The present invention relates to an optical element and an optical module using the optical element.

### BACKGROUND ART

In recent years, demand for 3D sensing for recognizing a three-dimensional shape of an object such as face authentication and space authentication has increased. As a method of 3D sensing, a time of flight (TOF) method, a structured light method, and the like are adopted. In these methods, distance measurement is performed by irradiating a target object with light from a laser light source such as a vertical cavity surface emitting laser (VCSEL) via an optical element, and detecting reflected light.

As an optical element used for the 3D sensing, a diffractive optical element (DOE) in which a plurality of optical elements are arranged and a micro lens array (MLA) are known. This diffractive optical element is used for the purpose of condensing light from a light source in a predetermined pattern, and the micro lens array is often used for the purpose of optically uniformizing the light from the light source (hereinafter, the diffractive optical element and the micro lens array are collectively referred to as micro-optical element).

Then, in a case of using a light source having strong directivity such as the VCSEL as described above, for example, in a case of a DOE that emits a dot pattern, when light with strong directivity enters, the pattern also becomes light having directivity, and thus there has been a case where the pattern becomes blurred and desired optical characteristics cannot be obtained. On the other hand, in a case of an MLA that emits uniform light, when light with strong directivity enters, the irradiation pattern becomes blurred, and there has been a case of an occurrence of false recognition of a camera or efficiency drop.

For this, it is necessary to use a collimator lens in combination to make incident light entering the micro-optical element into parallel light. However, in a prior art, a lens unit including a plurality of components is provided by assembling a collimator lens and a micro-optical element to a holder as separate components, which causes an increase in manufacturing cost and a decrease in yield (see, for example, Patent Document 1).

In a case of using a reflow-compatible collimator lens, there has been no choice but to use a glass hybrid lens, and there has been no choice but to use a collimator lens by a diffractive Fresnel lens. The collimator lens using a diffractive Fresnel lens has a disadvantage that the efficiency with respect to the surface light source is lowered as compared with the collimator lens using a refractive lens.

### CITATION LIST

### Patent Document

Patent Document 1: US 2013/0038881 A

### SUMMARY OF INVENTION

### Technical Problem

The technology of the present disclosure has been made in view of the above circumstances, and an object thereof is to provide a technology that can improve efficiency of or simplify a structure of an optical system having a collimating function of collimating incident light and a function of diffusing or condensing parallel light.

### Solution to Problem

The present disclosure for solving the above-described problem is an optical element including a function configured to make parallel light into outgoing light by diffusing the parallel light or condensing the parallel light to form a specific pattern, on one surface, and
a collimating function configured to make incident light into parallel light by an aspherical lens shape, on the other surface.

According to this, since in the optical element, the surface on which incident light is incident integrally includes a collimating function, it becomes possible to achieve a function of making incident light into outgoing light by diffusing the incident light or condensing the incident light to form a specific pattern with a simpler structure. By using an aspherical lens shape for the collimating function, incident light can be made into parallel light more efficiently also when a surface light source is used.

In the present disclosure, an SAG in the aspherical lens shape may be 1 μm or greater and 500 μm or less. Alternatively, the SAG may be 100 μm or greater and 400 μm or less. This makes it possible to suppress a change in optical characteristics by applying AR coating, and possible to more reliably increase the efficiency.

In the present disclosure, around the aspherical lens shape on the other surface, a wall portion may be provided to surround the aspherical lens shape, and
a tip end of the wall portion may be formed to protrude in a range of 0.01 mm or greater and 0.2 mm or less from an apex of the aspherical lens shape. This enables the aspherical lens shape to be protected by the wall portion, and handling of the optical element to be facilitated.

In the present disclosure, the efficiency as a ratio of the intensity of the outgoing light to the intensity of the incident light may be 60% or greater. This makes it possible to obtain outgoing light with higher intensity.

The present disclosure may have a function configured to make the parallel light into outgoing light by diffusing the parallel light or condensing the parallel light to form a specific pattern by a micro lens array or a diffractive optical element formed on the one surface. Alternatively, the present disclosure may have a function configured to make the parallel light into outgoing light by diffusing the parallel light or condensing the parallel light to form a specific pattern by a micro lens array formed on the one surface. This makes it possible to achieve a function configured to make parallel light into outgoing light by diffusing the parallel light or condensing the parallel light to form a specific pattern in a more space-saving or low-cost manner.

In the present disclosure, the incident light may be light having predetermined directivity. This makes it easy to use low power consumption and low cost light source such as a vertical cavity surface emitting laser.

In the present disclosure, an AR coating layer may be formed on a surface having the aspherical lens shape. This makes it possible to more reliably increase the efficiency of the optical element.

In the present disclosure, heat-resistant temperature of the optical element may be 260° C. or higher. This makes it possible to cause a substrate mounted with the optical element to pass through a reflow furnace as it is.

The present disclosure may be integrally formed of resin. This makes it possible to eliminate an interface inside the optical element and to further increase the efficiency. Separation in the optical element can be prevented, and reliability can be increased. Restrictions on the thickness and the shape can be reduced, and the degree of freedom in design can be increased. A load can be reduced during dicing for dividing an optical element wafer into individual optical elements. It becomes easy to add a shape for securing the strength of a rib and the like.

The present disclosure may be an optical module including the optical element, a light source of the incident light, and a holder that holds the optical element and the light source. This makes it possible to manufacture a module that emits light to be diffused or condensed to form a specific pattern with a small number of components, simple man-hours, and low cost.

In the optical module, the light source of the incident light may be a vertical cavity surface emitting laser light source. This makes it possible to provide an optical module with lower power consumption and lower cost.

Note that, in the present invention, wherever possible, the techniques for solving the above-described problem can be used in combination.

### Advantageous Effects of Invention

According to the present disclosure, it becomes possible to improve efficiency of or simplify a structure of an optical system having a collimating function configured to collimate incident light and a function configured to diffuse or condense parallel light.

### BRIEF DESCRIPTION OF DRAWINGS

FIG. 1 is a schematic view illustrating a system that causes light emitted from a light source to pass through an optical element and irradiates a target object with the light.

FIG. 2 is a cross-sectional view of a known optical element and a partially enlarged view thereof.

FIG. 3A and FIG. 3B are schematic cross-sectional views of an optical element according to the present disclosure.

FIG. 4A and FIG. 4B are second schematic cross-sectional views of the optical element according to the present disclosure.

FIG. 5 is a view illustrating specifications of each optical element.

FIG. 6A and FIG. 6B are views illustrating a formation method of the optical element according to the present disclosure in a case of integral molding with resin.

FIG. 7A and FIG. 7B are second views illustrating the formation method of the optical element according to the present disclosure in the case of integral molding with resin.

FIG. 8A and FIG. 8B are views illustrating the formation method of the optical element according to the present disclosure in a case of forming with a resin material and a glass material.

FIG. 9A and FIG. 9B are second views illustrating the formation method of the optical element according to the present disclosure in the case of forming with a resin material and a glass material.

FIG. 10A and FIG. 10B are third views illustrating the formation method of the optical element according to the present disclosure in the case of forming with a resin material and a glass material.

FIG. 11 is a view illustrating a schematic configuration of an optical module using the optical element of the present disclosure.

### DESCRIPTION OF EMBODIMENTS

Hereinafter, an optical element and an optical module according to an embodiment of the present disclosure will be described with reference to the drawings. Note that each of the configurations, combinations thereof, and the like in the embodiment are an example, and various additions, omissions, substitutions, and other changes may be made as appropriate without departing from the spirit of the present disclosure. The present disclosure is not limited by the embodiment and is limited only by the claims.

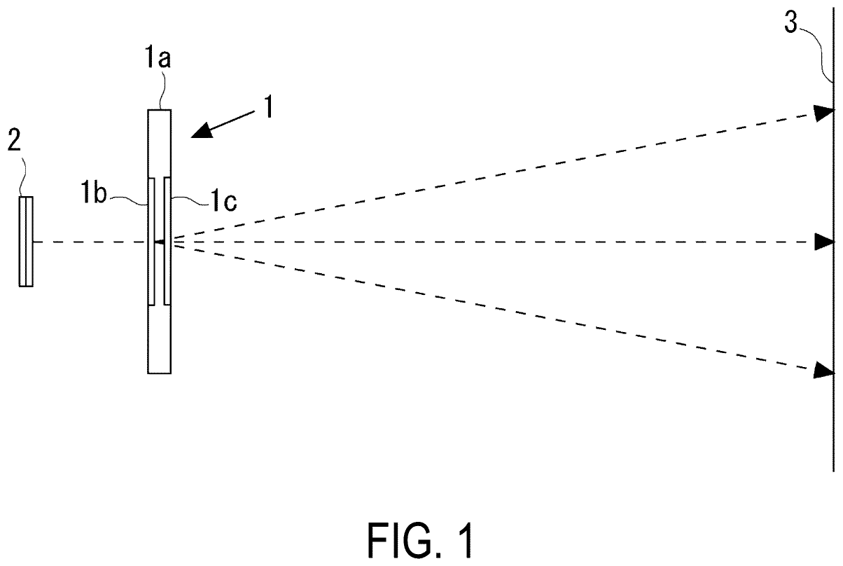

FIG. 1 is a schematic view of a system that causes light emitted from a light source 2 to pass through an optical element 1 and irradiates a target object (or an evaluation screen) 3 with the light. Here, the light source 2 is, for example, a vertical cavity surface emitting laser (VCSEL) light source. The light source 2 has directivity of, for example, about ±5 degrees, +10 degrees, or +20 degrees, but the level of directivity is not particularly limited. The optical element 1 includes a collimating portion 1b that converts incident light from the light source 2 into parallel light on a first surface of a base material 1a on the light source 2 side, and an optical characteristic portion 1c that has a characteristic of causing the parallel light having passed through the collimating portion 1b to be diffused or condensed to form a predetermined pattern on a second surface opposite to the light source 2. The light having passed through the optical element 1 is diffused with respect to an optical axis and emitted on the target object 3 with uniform intensity, or condensed to form a predetermined pattern (e.g., dot pattern) on the target object 3.

Examples of the optical characteristic portion 1c include a diffractive optical element and a micro lens array. The diffractive optical element is to change a traveling direction of light by using a diffraction phenomenon of light such as a grating hologram, and is to diffract light by a periodic structure (diffraction groove) formed on the second surface of the base material Ta to form arbitrary structure light. The micro lens array has a structure in which a plurality of micro lenses having a size of about several tens of micrometers are arranged, and has functions of diffusing and uniformizing incident light. Each micro lens constituting the micro lens array may have the same shape, or the micro lens array may have a random structure in which micro lenses having different shapes are arranged.

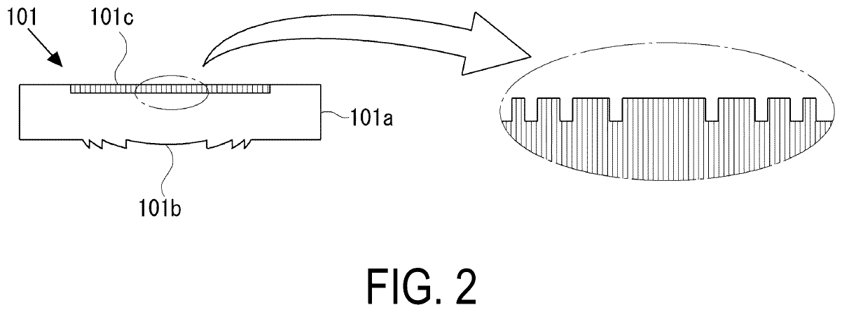

FIG. 2 illustrates a cross-sectional view of a known optical element 101 and a partially enlarged view thereof. The optical element 101 illustrated in FIG. 2 includes a Fresnel DOE 101b as a collimating portion that makes incident light into parallel light. The optical element 101 includes a DOE 101c as the optical characteristic portion. The view surrounded by an ellipse of a one-dot chain line is an enlarged view of a cross section of the DOE 101c. The DOE 101c includes a diffraction grating formed, and thus diffracted light of parallel light forms, for example, a dot pattern on the target object.

In the optical element 101 illustrated in FIG. 2, since the Fresnel DOE 101b is adopted as the collimating portion, a reflection surface is relatively increased, and it has been difficult to reduce the reflectance in the collimating portion. As a result, it has been difficult to increase the efficiency, which is the intensity ratio between the incident light and the outgoing light of the optical element 101. When coating is applied to the Fresnel DOE 101b as the collimating portion and the DOE 101c as the optical characteristic portion, the diffraction characteristics are changed, and therefore AR coating cannot be performed, and it has been also difficult to increase the efficiency in this regard.

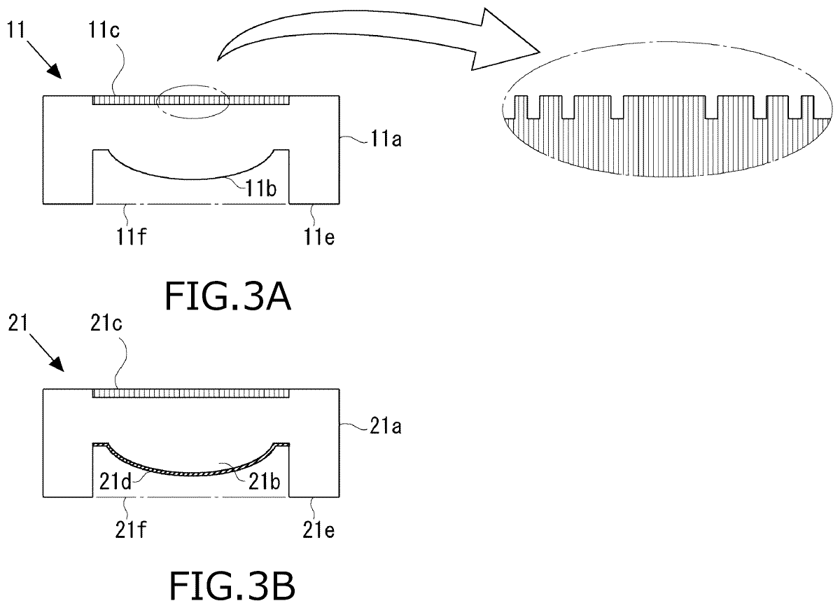

FIG. 3A and FIG. 3B are schematic cross-sectional views of the optical element 11 and an optical element 21 according to the present embodiment in which the above-described disadvantages of the prior art have been improved. The optical element 11 illustrated in FIG. 3A adopts an aspherical lens 11b as a collimating portion. As an optical characteristic portion 11c, a DOE is adopted similarly to the case of FIG. 2. According to this, since the aspherical lens 11b is adopted as the collimating portion, surface reflection in the collimating portion can be reduced, and incidence efficiency can be increased. In the optical element 21 illustrated in FIG. 3B, since change in optical characteristics due to application of coating is small in the lens optical system, anti reflection (AR) coating 21d is performed on an aspherical lens 21b. This makes it possible to further increase incidence efficiency.

Note that the optical elements 11 and 21 are provided with wall portions 11e and 21e and thus the aspherical lenses 11b and 21b are surrounded in plan view. By tip ends of the wall portions 11e and 21e, reference surfaces 11f and 21f of the optical elements 11 and 21 are formed, and the optical elements 11 and 21 can be placed and handled on the reference surfaces. The reference surfaces 11f and 21f by the wall portions 11e and 21e are preferably high in a range of 0.01 mm or greater and 0.2 mm or less with respect to apices of the aspherical lenses 11b and 21b. More preferably, they are high in a range of 0.02 mm or greater and 0.1 mm or less. This makes it possible to more reliably protect the aspherical lenses 11b and 21b by the wall portions 11e and 21e, and improve the handleability. The same applies to other optical elements in the present disclosure.

The AR coating may be composed of a single layer or multiple layers of metal oxide coating. Materials such as SiO₂, ZrO₂, Al₂O₃, and TiO₂ are commonly used as the material of the metal oxide. When the AR coating is composed of multiple layers, the formation material for each layer may be the same or different. As a film formation method of the AR coating, for example, a dry plating method (alternatively, dry coating method) such as a vacuum deposition method, an ion plating method, a sputtering method, a CVD method, or a PVD method may be adopted. As the vacuum deposition method, an ion beam assist method in which ion beams are simultaneously irradiated during the vapor deposition may be used.

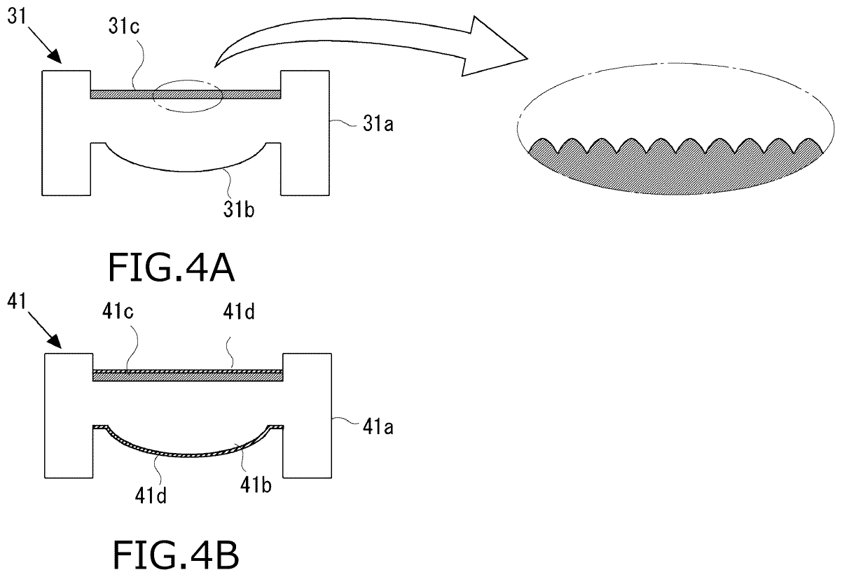

FIG. 4A and FIG. 4B illustrate schematic cross-sectional views of optical elements 31 and 41 according to the present embodiment. The optical element 31 illustrated in FIG. 4A adopts an aspherical lens 31b as a collimating portion. An MLA 31c is adopted as the optical characteristic portion. This makes it possible to suppress surface reflection in the collimating portion, and increase incidence efficiency. As illustrated in FIG. 4B, in the optical element 41, AR coating 41d is performed on an aspherical lens 41b, and a change in optical characteristics due to application of coating on the MLA is small, and therefore the AR coating 41d is also performed on an MLA 41c. This makes it possible to further increase the efficiency.

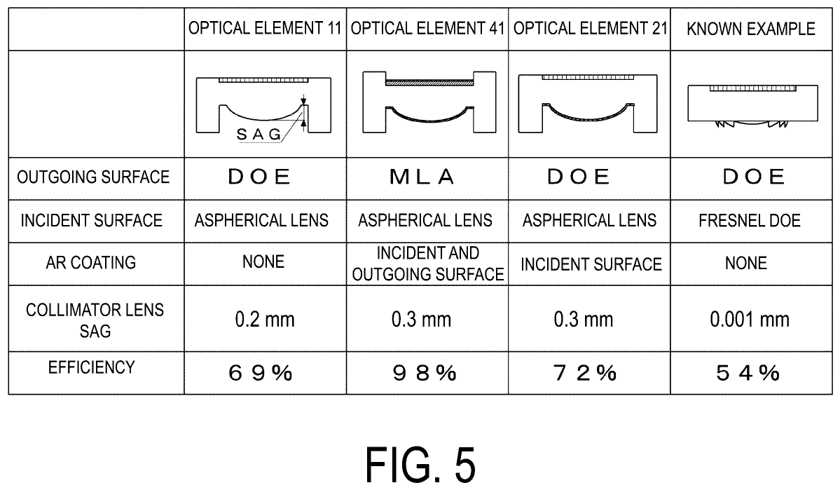

FIG. 5 is a view summarizing specifications of each of the optical elements described above. In the optical element 11, an efficiency of 69% was obtained when the SAG amount (here, the distance in the optical axis direction between the apex of the aspherical lens and the lens peripheral surface) was 0.2 mm. In the optical element 41, an efficiency of 98% was obtained when the SAG amount was 0.3 mm. In the optical element 21, an efficiency of 72% was obtained when the SAG amount was 0.3 mm. Note that in a case of the optical element 101 as a known example, the SAG amount corresponded to 0.001 mm, and the efficiency was 54%. This indicates that high efficiency can be obtained by adopting an aspherical lens as a collimating portion, appropriately selecting the SAG amount, and further performing AR coating.

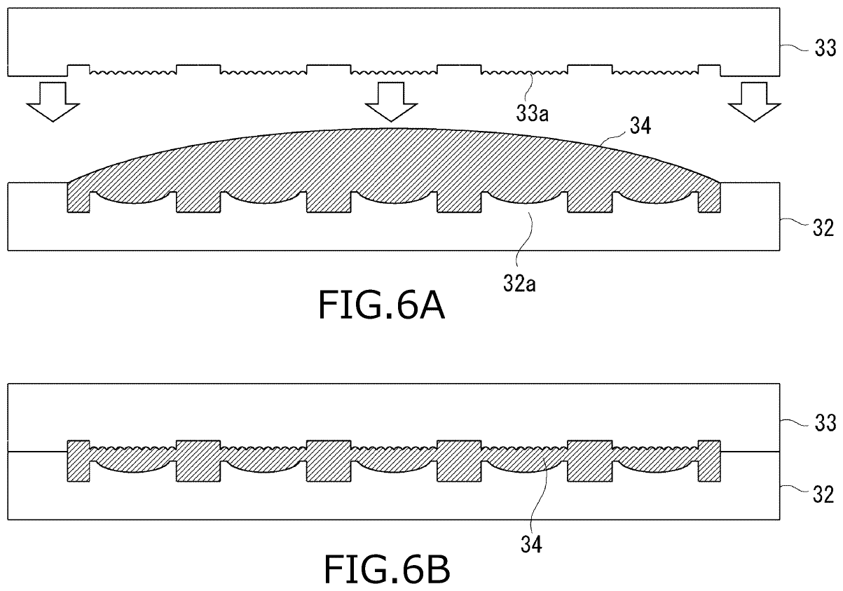

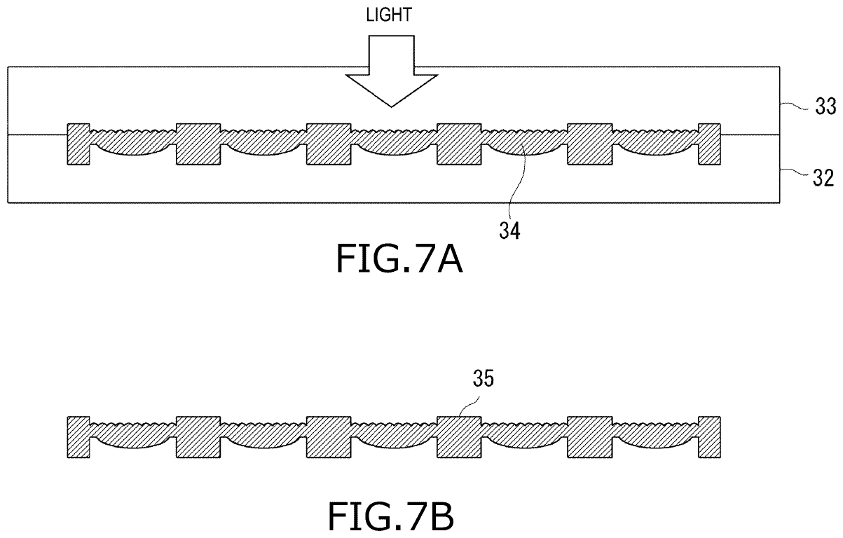

Next, a formation method of the optical element 31 according to the present embodiment in the case of integral molding with resin will be described with reference to FIG. 6A, FIG. 6B, FIG. 7A and FIG. 7B. Note that the optical elements other than the optical element 31 can also be formed by a similar method. Here, the present embodiment assumes a method for cutting out individual optical elements from an optical element wafer after molding by molding an optical element wafer integrally formed with a plurality of optical elements and performing dicing. A case where, in particular, a photocurable resin composition is used as a material of the optical element will be described. In this case, first, as illustrated in FIG. 6A, a lower mold 32 to which a shape 32a of the collimating portion has been transferred is filled with a resin material 34. Then, an upper mold 33 to which a shape 33a of the optical characteristic portion has been transferred is lowered from above, and the resin material 34 is pressed and molded as illustrated in FIG. 6B.

Then, as illustrated in FIG. 7A, in a state of being pressed by the lower mold 32 and the upper mold 33, the resin material 34 is cured by irradiating the resin material 34 with light for photocuring, for example, ultraviolet rays. As illustrated in FIG. 7B, the cured resin material 34 is taken out from the lower mold 32 and the upper mold 33 to complete an optical element wafer 35 as a molded product. Then, dicing is performed on the optical element wafer 35 to complete the individual optical elements 31. Note that here, at least the upper mold 33 is formed of a material having transparency to light in an ultraviolet region. More specifically, a material having a light transmittance of 90% or greater at a wavelength of 400 nm may be used, and a mold made of quartz or glass can be suitably used.

As described above, by forming the optical element 31 by integral molding of resin, an interface inside the element can be eliminated and the efficient optical element 31 can be formed. Since the optical element 31 is integrally molded using a single material, there is no disadvantage such as separation of a part of the optical element 31. The degree of freedom in design is high, and there are few restrictions on thickness and shape. Furthermore, since the dicing target is only the resin, the load on the processing device is less, and the processing time can be shortened. A complicated shape such as a rib can be given.

Note that in the above description, an application method of a photocurable resin composition is not particularly limited, and examples thereof include a method using a dispenser or a syringe. Examples of the light source for performing ultraviolet irradiation include a high-pressure mercury lamp, an ultra-high-pressure mercury lamp, a carbon arc lamp, a xenon lamp, and a metal halide lamp. The irradiation time varies depending on the type of light source, the distance between the light source and the application surface, and other conditions, but may be several tens of seconds at the longest. The illuminance may be about 5 mW to 200 mW. After the irradiation with ultraviolet rays, the curable composition may be heated (post-curing) as necessary to facilitate curing. The photocurable resin composition may be a composition containing a cationically curable compound as a curable compound, and more specifically, may be a composition containing epoxy resin.

Note that in the above description, an example of using a photocurable resin composition as a material of the optical element has been described, but the material of the optical element is not limited to this. For example, a thermosetting composition may be used as the curable composition. In this case, the curable composition can be cured not by irradiating the curable composition with light but by applying a heat treatment.

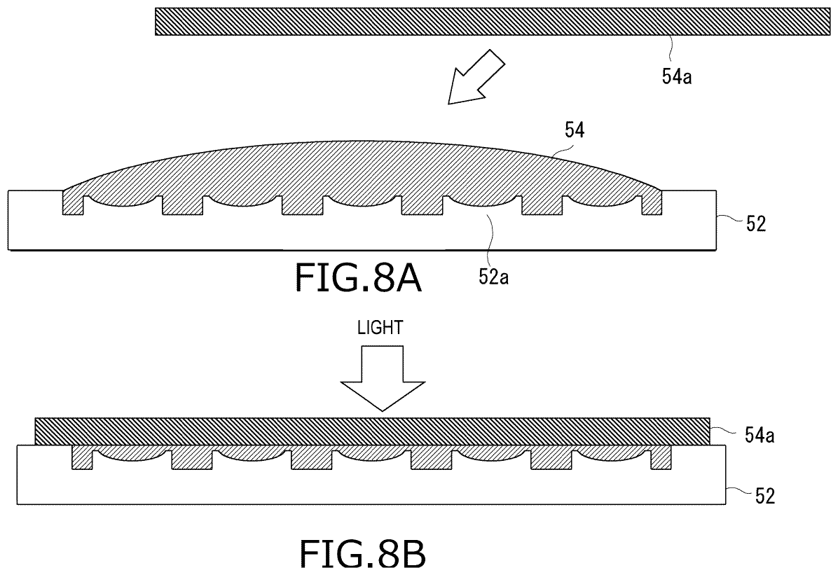

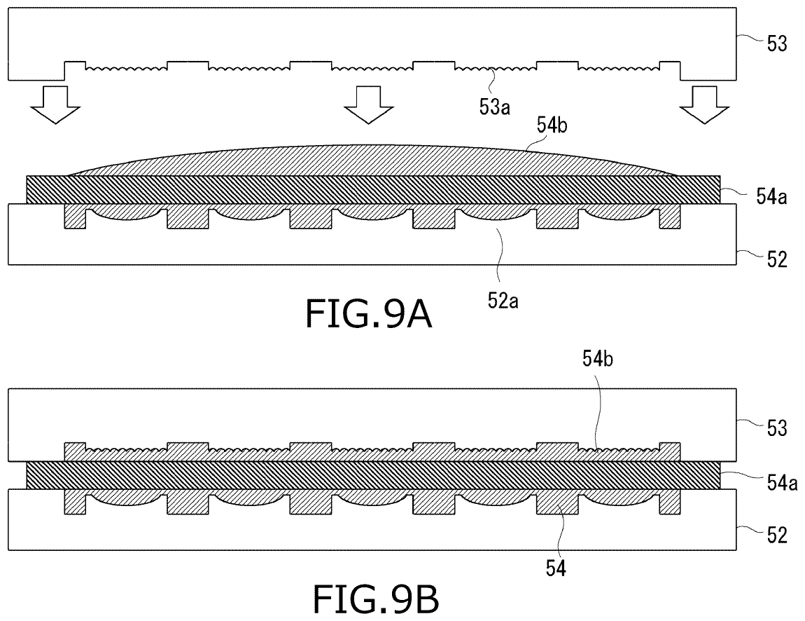

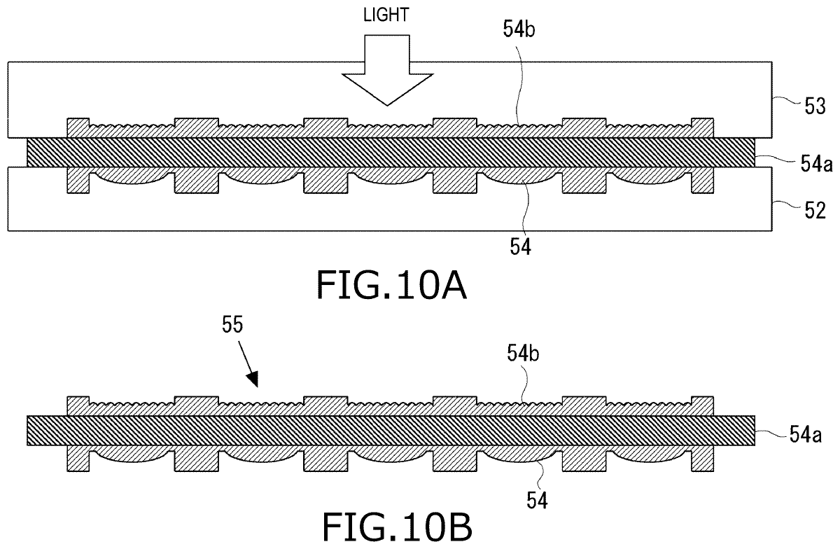

Next, a formation method in a case where the optical element 31 is formed of two materials of a resin material and a glass material will be described with reference to FIG. 8A, FIG. 8B, FIG. 9A, FIG. 9B, FIG. 10A and FIG. 10B. This case also assumes a method for cutting out individual optical elements from an optical element wafer after molding by molding an optical element wafer integrally formed with a plurality of optical elements and performing dicing. A case where, in particular, a photocurable resin composition is used as a material of the optical element will be described.

As illustrated in FIG. 8A, in the present embodiment, a lower mold 52 to which a shape 52a of the collimating portion has been transferred is filled with a resin material 54. Then, the resin material 54 is pressed from above by a glass substrate 54a. In this state, as illustrated in FIG. 8B, light for curing the photocurable resin composition, for example, ultraviolet light is emitted from above the glass substrate 54a to cure the resin material 54 and bond the resin material 54 and the glass substrate 54a to each other.

Then, as illustrated in FIG. 9A, a resin material 54b is supplied onto the glass substrate 54a, an upper mold 53 to which a shape 53a of the optical characteristic portion has been transferred is lowered from above, and as illustrated in FIG. 9B, the resin material 54, the glass substrate 54a, and the resin material 54b are pressed.

Then, as illustrated in FIG. 10A, in a state of being pressed by the lower mold 52 and the upper mold 53, the resin material 54b is irradiated with light for photocuring, for example, ultraviolet ray to cure the resin material 54b, and is bonded with the glass substrate 54a. Then, as illustrated in FIG. 10B, the molded products of the resin materials 54 and 54b and the glass substrate 54a are taken out from the lower mold 52 and the upper mold 53, thereby completing an optical element wafer 55. Then, dicing is performed on the optical element wafer 55 to complete the individual optical elements 31.

As described above, in the present embodiment, the optical element 31 can be formed by hybrid molding of the resin materials 54 and 54b and the glass substrate 54a. However, in that case, there is a risk that air bubbles are generated between the resin material 54 or 54b and the glass substrate 54a. There is a risk that the resin material 54 or 54b and the glass substrate 54a are separated. There is a risk that the efficiency decreases due to reflection at the interface between the resin material 54 or 54b and the glass substrate 54a.

Furthermore, since the shape of the glass substrate 54a is exposed, handling may become difficult. The thickness of the entire optical element 31 cannot be made equal to or less than the thickness of the glass substrate 54a. It cannot be attached to a dicing tape. Regarding dicing of the glass substrate 54a, there is a risk that quality improvement is difficult and the processing time becomes long.

Note that in the present embodiment, an example in which the diffractive optical element is also formed by resin molding has been described, but a method of forming a desired optical pattern on a resin material by electron beam lithography or the like can also be adopted for the diffractive optical element.

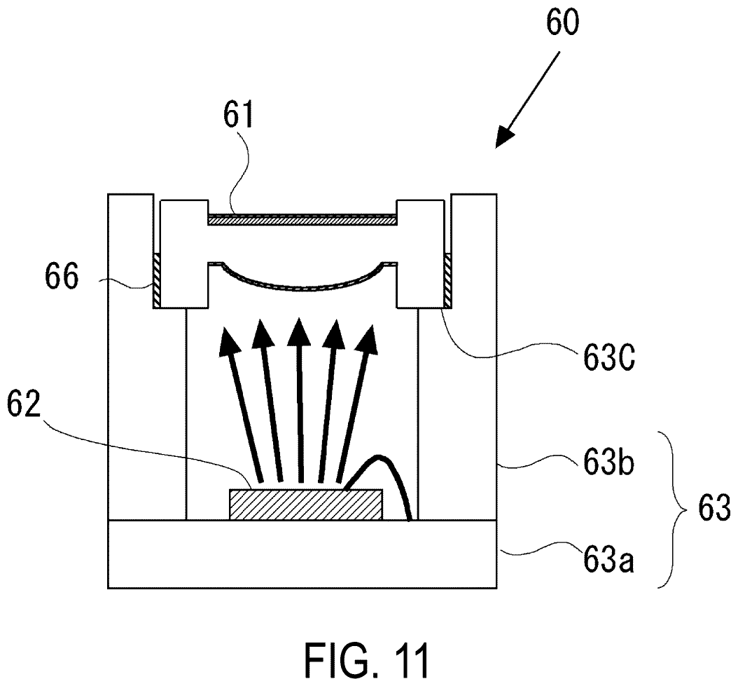

Next, an example of configuring an optical module 60 by combining an optical element 61 equivalent to the optical element described in the present embodiment, a light source 62, and a light source control unit (not illustrated) will be described with reference to FIG. 11. In FIG. 11, the optical module 60 includes an enclosure 63 having a base portion 63a on which the light source 62 is installed and a side wall portion 63b surrounding the light source 62. The optical element 61 is fixed to the side wall portion 63b by placing a rib portion on a step portion 63c provided inside the side wall portion 63b and bonding the rib portion with an adhesive 66.

As the light source 62, the above-described vertical cavity surface emitting laser (VCSEL) light source is used. A light source control unit (not illustrated) may also be placed on a base portion 63a.

As described above, by storing the optical element according to the present embodiment and the light source in one enclosure to provide an optical module, the configuration of the optical module can be simplified and the cost can be reduced. The optical module 60 may be used alone for illumination, or may be used by being incorporated in a measurement device such as a TOF system or a structure light system distance measurement device, or another device.

An optical element having a function equivalent to that of the optical element described in the present embodiment may be used as an optical system for image photographing, for face authentication in security equipment, or for space authentication in a vehicle or a robot.

### Wiring of Electrically Conductive Substance

Note that the surface or inside of the optical element according to the present embodiment may be provided with wiring containing an electrically conductive substance, and damage of the collimating portion or the optical characteristic portion may be detected by monitoring the conduction state of the wiring. This makes it possible to easily detect damage such as cracks and separation of the collimating portion or the optical characteristic portion, and therefore it makes it possible to prevent in advance damage due to defect or malfunction of an illumination device or a distance measurement device caused by damage of the optical element. For example, by detecting occurrence of a crack in the collimating portion or the optical characteristic portion by disconnection of the electrically conductive substance and prohibiting light emission of the light source, 0th-order light from the light source can be avoided from directly passing through the optical element via the crack and from being emitted to the outside.

The wiring of the electrically conductive substance may be provided on or around the collimating portion or the optical characteristic portion. The electrically conductive substance is not particularly limited as long as it has electrical conductivity, and for example, metal, metal oxide, electrically conductive polymer, an electrically conductive carbon-based substance, or the like can be used.

More specifically, the metal includes gold, silver, copper, chromium, nickel, palladium, aluminum, iron, platinum, molybdenum, tungsten, zinc, lead, cobalt, titanium, zirconium, indium, rhodium, ruthenium, and alloys thereof. Examples of the metal oxide include chromium oxide, nickel oxide, copper oxide, titanium oxide, zirconium oxide, indium oxide, aluminum oxide, zinc oxide, tin oxide, or composite oxides thereof such as composite oxides of indium oxide and tin oxide (ITO) and complex oxides of tin oxide and phosphorus oxide (PTO). Examples of the electrically conductive polymer include polyacetylene, polyaniline, polypyrrole, and polythiophene. Examples of the electrically conductive carbon-based substance include carbon black, SAF, ISAF, HAF, FEF, GPF, SRF, FT, MT, pyrolytic carbon, natural graphite, and artificial graphite. These electrically conductive substances can be used alone, or two or more types thereof can be used in combination.

As the electrically conductive substance, metal or metal oxide that is excellent in conductivity and easily forms wiring is preferable, metal is more preferable, gold, silver, copper, indium, and the like are preferable, and silver is preferable in terms of being mutually fused at a temperature of about 100° C. to be capable of forming wiring excellent in conductivity even on an optical element made of resin. A pattern and a shape of the wiring of the electrically conductive substance are not particularly limited. The pattern may be a pattern surrounding the optical element, or the pattern may have a complicated shape and thus further improves detectability of cracks and the like. Furthermore, the pattern may be a pattern in which at least a part of the optical element is covered with a transparent electrically conductive substance.

### REFERENCE SIGNS LIST

1, 11, 21, 31, 41, 61, 101 . . . Optical element
1a . . . Base material
1b . . . Collimating portion
1c . . . Optical characteristic portion
2, 62 . . . Light source
3 . . . Target object
11b, 21b, 31b, 41b . . . Aspherical lens
11c, 21c . . . Diffractive optical element (DOE)
21d, 41d . . . AR coating
31c, 41c . . . Micro lens array (MLA)
60 . . . Optical module

1: An optical element comprising
a function configured to make parallel light into outgoing light by diffusing the parallel light or condensing the parallel light to form a specific pattern, on one surface, and
a collimating function configured to make incident light into parallel light by an aspherical lens shape, on the other surface.

2: The optical element according to claim 1, wherein
SAG in the aspherical lens shape is 1 μm or greater and 500 μm or less.

3: The optical element according to claim 1, wherein
SAG in the aspherical lens shape is 100 μm or greater and 400 μm or less.

4: The optical element according to claim 1, wherein
around the aspherical lens shape on the other surface, a wall portion is provided to surround the aspherical lens shape, and
a tip end of the wall portion is formed to protrude in a range of 0.01 mm or greater and 0.2 mm or less from an apex of the aspherical lens shape.

5: The optical element according to claim 1, wherein
an efficiency as a ratio of an intensity of the outgoing light to an intensity of the incident light is 60% or greater.

6: The optical element according to claim 1, comprising:
a function configured to make the parallel light into outgoing light by diffusing the parallel light or condensing the parallel light to form a specific pattern by a micro lens array or a diffractive optical element formed on the one surface.

7: The optical element according to claim 1, comprising;
a function configured to make the parallel light into outgoing light by diffusing the parallel light or condensing the parallel light to form a specific pattern by a micro lens array formed on the one surface.

8: The optical element according to claim 1, wherein
the incident light is light having predetermined directivity.

9: The optical element according to claim 1, wherein
an AR coating layer is formed on a surface having the aspherical lens shape.

10: The optical element according to claim 1, wherein
heat-resistant temperature is 260° C. or higher.

11: The optical element according to claim 1, wherein
the optical element is integrally formed of resin.

12: An optical module comprising:
the optical element according to claim 1;
a light source of the incident light; and
a holder holding the optical element and the light source.

13: The optical module according to claim 12, wherein
the light source of the incident light is a vertical cavity surface emitting laser light source.
